(19) United States
(12) Patent Application Publication
(10) Pub. No.: US 2003/0029651 A1
(43) Pub. Date: Feb. 13, 2003

(54) Electronically controlled tractor trailer propulsion braking and stability systems

(76) Inventor: Frank A. Palmeri, Troy, MI (US)

Correspondence Address: Carlson, Gaskey & Olds, PC, Ste. 350, 400 West Maple Road, Birmingham, MI, 48009, US

(21) Appl. No.: 10/268,255

(22) Filed: Oct. 10, 2002

Related U.S. Application Data
(63) Continuation of application No. 09/243,597, filed on Feb. 3, 1999, now abandoned.

(51) Int. Cl. B60K 1/00

(52) U.S. Cl. 180/65.1

(57) ABSTRACT

A combined electrical system is utilized to control propulsion, braking, stability and steering of a combined tractor trailer combination. In particular, electric motors are associated with each wheel on the tractor and the trailer. The electrical motors are driven to provide propulsion to the wheels. By utilizing propulsion units on the trailer, the overall stability of the system is improved. Further, the same electrical motors can be utilized to retard rotation of an associated wheel, and thus provide braking. In addition, an electrical control may also be utilized to control steering and suspension.

### BACKGROUND OF THE INVENTION

This invention relates to an electronically controlled system for providing propulsion, braking and stability control to a tractor and trailer combination.

In the prior art, many heavy vehicles include a combined tractor and trailer. As known, the tractor is provided with the engine and the drive train, and the trailer is connected to the tractor. Brakes are provided on both the tractor and the trailer. However, the drive train is typically provided entirely on the tractor.

The resultant combination requires a relatively large engine on the tractor which is capable of providing propulsion for the combined tractor and a fully loaded trailer. At many times, this may be more propulsion than is necessary for the tractor, such as when it is utilized without a fully loaded trailer, or with no trailer at all. Moreover, there are rollover concerns due to the fact that the propulsion is all at one end of the rather long combined vehicle. As an example, when the vehicle is turning, there may be rollover forces encountered near the rear of the trailer which reduce the stability of the combined tractor trailer. Thus, it could be said combined tractors and trailers are inherently unstable due to the propulsion being at one end of the vehicle, the braking being spaced along the vehicle at various axles, and the stability being provided through suspension systems at each axle.

### SUMMARY OF THE INVENTION

In the disclosed embodiment of this invention, an electrical control system is provided for distributing propulsion across both the tractor and trailer In the disclosed embodiment, electric motors are provided for driving each of the axles on both the tractor and the trailer. Alternatively, the electric motors may only need be provided on the trailer, and the tractor could be provided with a standard drive train, but a somewhat smaller engine.

The propulsion is thus provided by electric motors which can be relatively small compared to the total combined propulsion force required by the single prior art engine. The electrical motors also provide propulsion at each axle, and thus the stability problems that are encountered when the propulsion is at one end of the combined vehicle are eliminated. That is, the rear of the trailer will be inherently more stable now that the propulsion is also being provided at the rear of the trailer than was the case with the prior art systems.

Further, braking is preferably provided by the same electrical motors. Electrical motors are known wherein the electrical force of the motor can be utilized to retard rotation of the axle. A simple control is thus operable to provide both propulsion and braking. Moreover, as contrasted to the prior art systems, the braking is not occurring on axles which do not include propulsion. Again, providing the braking on the same axles which receive the propulsion, and not providing braking at axles which do not receive propulsion increases the overall stability of the combined tractor trailer system.

Further, the electrical system can be utilized to control steering and suspension. So-called steer by wire systems have been proposed wherein electrical controls are utilized to steer electrically controlled components. With the present invention, steering could be achieved by driving a motor associated with one wheel at a greater speed than the opposed wheel to turn the vehicle. Alternatively, steerable axles can also be utilized with electronically controlled steering mechanisms.

Further, electrically controlled suspension systems can be included which are actuated to provide electrical suspension to the vehicle system.

In sum, a combined control may be utilized for complete control of propulsion braking and stability of the overall combined tractor trailer system. These and other features of the present invention can be best understood from the following specification and drawings.

### BRIEF DESCRIPTION OF THE DRAWINGS

FIG. 1 is a side view of a schematic tractor trailer system.

FIG. 2 is a top view of the FIG. 1 system.

FIG. 3 is a side view of one wheel associated with the proposed system.

### DETAILED DESCRIPTION OF A PREFERRED EMBODIMENT

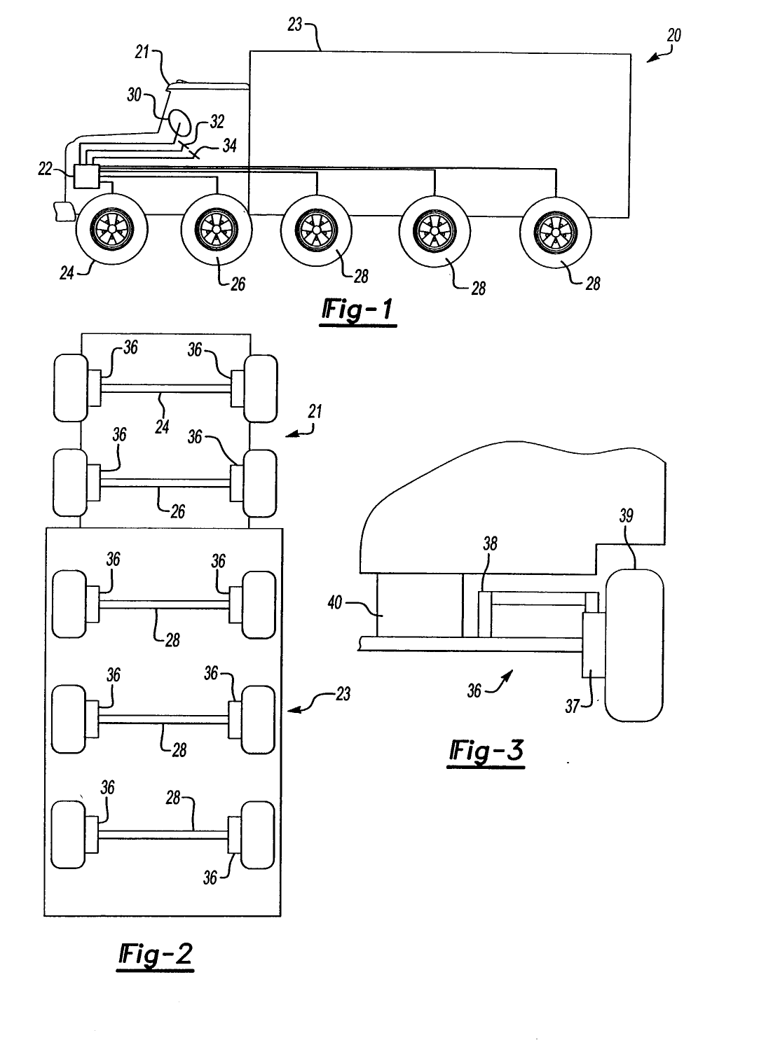

FIG. 1 shows a combined tractor trailer 20 including a tractor 21 and a trailer 23. A control 22 is illustrated provided on the tractor 21. The tractor 21 is provided with two axles 24 and 26. Typically, axle 24 is steerable.

The trailer 23 is shown having three axles 28. As known, trailers often have many more axles. In the prior art, propulsion is typically provided to the combined system 20 solely from the tractor. On the other hand, braking is provided by brakes mounted not only on the tractor axles, but also on at least some of the trailer axles. As mentioned above, this has lead to some stability issues.

In the present invention, a completely electrical control is utilized at least to provide propulsion. More preferably, the control also electronically controls braking, steering and stability.

As shown in FIG. 1, the accelerator pedal 32 communicates to the control 22 through a known electrical connection. The brake pedal 34 is also shown having a schematic electronic link to the control 22. Further, the steering wheel 30 is provided with a schematic electronic link to the control 22.

As shown in FIG. 2, electrical units 36 are associated with the wheels at each end of each of the axles 24, 26 and 28. In the figure illustrated in FIG. 2, each of the axles are provided with the electrical units 36. It may be possible in some applications that a few axles need not provided with the electrical control units on a trailer having a large number of axles. However, it is preferred that each axle be provided with a unit 36.

As shown in FIG. 3, each unit 36 includes a motor 37. The motor 37 is utilized to provide propulsion to the wheel 39 at each end of the axle. Moreover, the motor 37 is of the type which can be utilized to provide retardation of the rotation. Known motor controls can be utilized to either drive the wheel 39, or be controlled to slow its rotation. That is, if a braking signal is received the motors would be used to slow rotation. If an acceleration signal is received the motors would drive the axles. The exact type of control utilized is not part of this invention, but would be within the skill of a worker in this art. Instead, it is the use of the electric motor at the wheel, and in particular on the trailer, which is inventive. Moreover, the combined use of the motor for both braking and propulsion is also novel when applied to the particular type of environment.

Steering mechanism 38 is shown schematically. Steering mechanism 38 is also electrically controlled such that when the operator provides a steering signal through the steering wheel 30, the control 22 will be operable to actuate the mechanism 38 and steer the wheels. Mechanism 38 need not be provided with each of the axles 24, 26 and 28. Rather, the steering would tend to be provided with only certain of the axles.

Alternatively, steering could be controlled by using the motors for rotating the wheels 39 at each end of the axles at different speeds. This would then turn the vehicle. The controls for achieving this function would be within the skill of a worker in this art. It is the provision of such a function into this environment which is inventive.

Finally, a suspension 40 is illustrated in this figure. Suspension 40 may be the type of electrically controlled suspension which is able to be actuated to control the amount of fluid pressure provided to the suspension, and vary the suspension force. Alternatively, it may be possible to provide a solely electrically powered suspension. One fluid controlled suspension that would be operable for this portion of the invention is available from Meritor/Wabco, and known as a ECAS system. Again, a suspension need not be provided at each axle.

A preferred embodiment of this invention has been disclosed. However, a worker of ordinary skill in this art would recognize that certain modifications would come within the scope of this invention. For that reason the following claims should be studied to determine the true scope and content of this invention.

What is claimed is:

1. A combined tractor trailer comprising:
a tractor connected to a trailer, said tractor being provided with at least one axle having wheels at opposed ends, and said trailer being provided with at least one axle having wheels at opposed ends; and
an electric motor for driving said wheels associated with said at least one axle on said trailer.

2. A system as recited in claim 1, wherein an electrical motor is provided for driving each of said wheels associated with said at least one axle on said tractor.

3. A system as recited in claim 2, wherein there are a plurality of axles associated with said trailer.

4. A system as recited in claim 3, wherein each of said plurality of axles on said trailer is provided with electrical motors at each end.

5. A system as recited in claim 1, wherein said electrical motor is provided with a control such that it is operable to drive said wheels, and further such that it is operable to retard rotation of said wheels upon receipt of a braking signal.

6. A system as recited in claim 1, wherein a suspension is provided to said at least one axle associated with said tractor, said suspension being electrically controlled by an electrical control.

7. A system as recited in claim 1, wherein at least one of said at least one axle on said tractor and said trailer is steerable, and there being an electrical control for achieving steering.

8. A system as recited in claim 7, wherein said electrical control actuates a steering member to provide steering.

9. A system as recited in claim 7, wherein said electrical control controls the motors associated with said wheels at opposed ends of said at least one axle to rotate at differing speeds to achieve steering.

10. A trailer for attachment to a tractor comprising:
at least a pair of axles, each of said axles having wheels at opposed ends, and said wheels at each of said opposed ends of said at least a pair of axles being provided with an electrical motor, said electrical motor being operable to drive said axles.

11. A trailer as recited in claim 10, wherein said motors are also operable to be actuated to retard rotation of an associated wheel and provide braking.

12. A system as recited in claim 10, wherein a suspension supports said axle on said trailer, said suspension being electrically controlled.

13. A method of operating a combined tractor trailer comprising the steps of:
(1) providing a tractor and trailer, at least said trailer being provided with an axle having wheels at an opposed end, and electrical motors for driving each of said wheels at said opposed ends of said axle; and
(2) driving said electrical motors to rotate said wheels at said opposed end of said axle and provide propulsion to said trailer.

14. A method as recited in claim 13, wherein said motors are also controlled to retard rotation of said wheels when a braking signal is received.

15. A method as recited in claim 13, wherein an electrical control receives a request for steering and communicates with electrical devices associated with at least two wheels on at least one axle associated with said tractor or said trailer, said electrical control then causing said wheels to be actuated to turn said vehicle.

16. A method as recited in claim 15, wherein a steering mechanism is actuated to turn said wheels.

17. A method as recited in claim 15, wherein one of said wheels is rotated at a different speed than the other of said wheels to cause said rotation.
